(19) United States
(12) Patent Application Publication
(10) Pub. No.: US 2003/0094243 A1
(43) Pub. Date: May 22, 2003

(54) System comprising an applicator/dispenser and a rolled strip, and use thereof by pushing the dispenser forward

(76) Inventors: Jean Joseph Marie Charriere, Briare (FR); Marie Therese Georgette Charriere, Briare (FR)

Correspondence Address: NOTARO & MICHALOS P.C., Suite 110, 100 Dutch Hill Road, Orangeburg, NY, 10962-2100, US

(21) Appl. No.: 10/272,769

(22) Filed: Oct. 17, 2002

(30) Foreign Application Priority Data
Oct. 19, 2001 (FR) 0113514

(51) Int. Cl. B44C 7/06

(52) U.S. Cl. 156/577

(57) ABSTRACT

The system comprises, on the one hand, a dispensing device, and on the other hand, at least one roll of strip of great length having a central opening optionally associated with a hub or a core, said system being provided with means for guiding an unwound free end of strip out of the dispenser and applying it to a surface known as the “destination surface,” said device comprising:

a front portion comprising a location for at least one removable roll able to rotate relative to said front portion on a virtual axis transverse thereto,

an applying roller mounted to be rotatable transversely,

a maneuvering handle.

It is characterized in that the removable roll (200) and the applying roller (106) are associated with a position-maintaining mechanism (108-113) designed to urge either the roll (200) toward the applying roller (106) or the applying roller (106) toward the roll (200), so that these two elements (200 and 106) are maintained constantly in tangential contact with each other.

The instant invention relates to systems designed to apply segments of a strip of great length to a surface referred to as the “destination surface.”

Already known are dispensers designed to apply adhesive tape, particularly for sealing cardboard containers, and sometimes referred to as “gun dispensers.”

This being relatively rough work, the existing devices are, above all, robust, but are not designed for delicate and meticulous work that demands precision, as is the case, for example, with printed-strip borders that are to be applied near the angles of a residential room being decorated.

To place the prior art in context, the following patents may be cited:

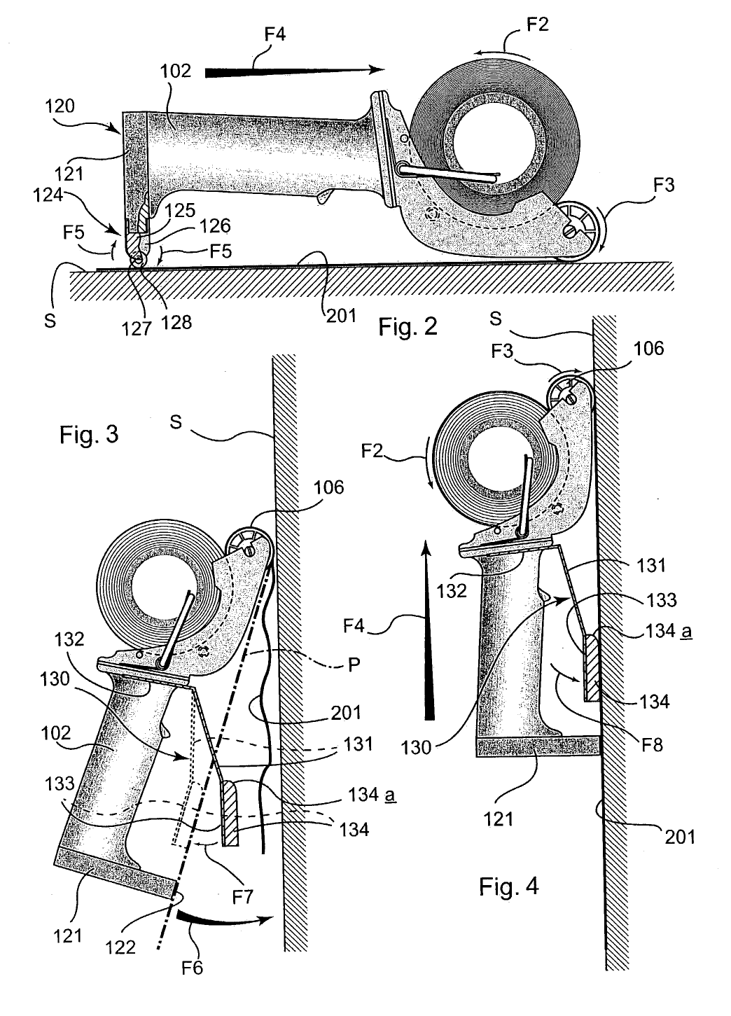

SE 506 709, which concerns a device very typical of those that exist in different variants but are all designed on the same principle. The description provided in this document is particularly clear in showing that the strip to be applied passes over a return cylinder 20 before coming into contact with an applying roller 5 via the back of said roller 5, so that for the device to be used it has to be pulled backward, the strip 23 being deposited in front (FIGS. 2 and 3).

U.S. Pat. No. 4,608,116 which describes a system having a twofold function: that of unwinding and applying a tape¹, and that of cutting the applied tape. To this end, the device includes a cutting mechanism that operates when the operator pivots the device in a plane perpendicular to that of the applied tape, and this function alone makes it necessary for the tape to be held taut above the cutting line, ¹TRANSLATOR'S NOTE: It should be noted that the French word ruban means both “strip” and “tape,” so the use of either of these two words in this translation has been at our discretion. For the purposes of the original, each should be assumed to imply the other.

requiring the presence of two rollers 26 and 28 that pinch the tape between them.

The presence of these two rollers is made possible only by the specific arrangement of the roll of tape 20, which must be mounted on an axial support 22. This is because its outer diameter gradually decreases as the turns of tape unwind, in correlation with the length of tape being applied, and it must be possible to mount a new roll 20 of maximum diameter on the axial support 22 without its periphery touching the rollers 26-28. Upstream of these rollers 26-28, therefore, there is always a free length of tape 24 between its region of contact with the reserve turns and the rollers 26-28.

The system according to the instant invention provides that the periphery of the roll always remains in contact with a single applying roller. Thus, there is never a free length of tape upstream of the applying roller, and when the operator cuts the applied tape with a simple hand-operated cutting blade, the part of the tape that trails the device remains taut despite the absence of two pinching rollers as provided in U.S. Pat. No. 4,608,116.

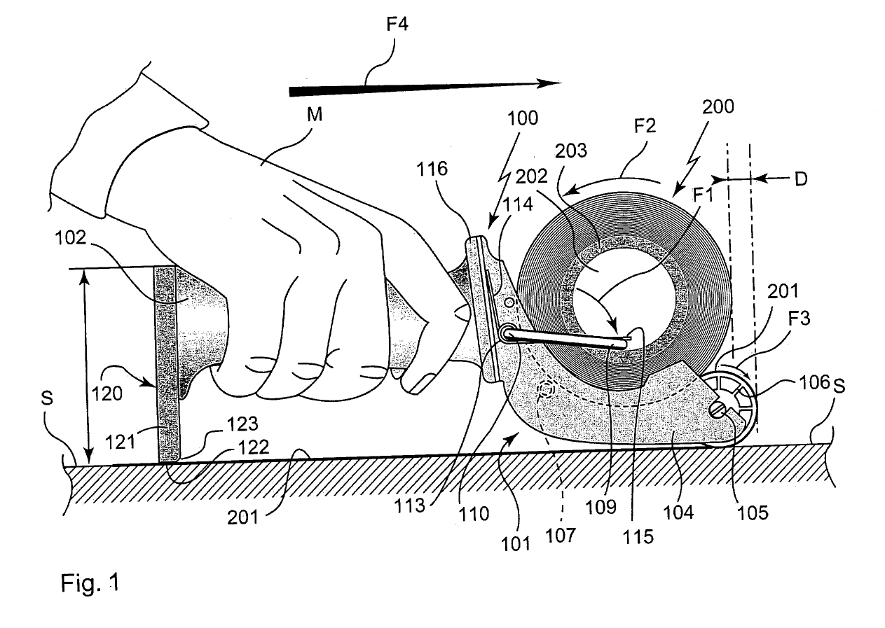

U.S. Pat. No. 3,325,336, which comprises a single applying roller 18; however, the roll 16 is also mounted on a core 15 with a positionally fixed axis and there is a free length of tape upstream of the applying roller 18, which is clearly evident in FIG. 1 at the site of reference numeral 16, denoting the unwound tape upstream and downstream of applying roller 18.

This document is silent as to what becomes of this free length of tape once it has been cut, nor does it say how the cutting is done.

U.S. Pat. No. 3,537,942, which has the same structural characteristics as the two preceding patents, thus requiring no further comment, and further has a prohibitive disadvantage, i.e., that the tape roll 40 is positioned in such a way that its periphery is upstream of the applying roller 25, thus utterly preventing the tape T from being applied to a wall, for example, since the roll 40 would strike the wall before the applying roller 25 could reach it.

All these systems are portable, obviously, since the tape is applied to a fixed destination surface. They essentially include a support for the roll of tape to be applied, an applying roller disposed at the front of the device, and a maneuvering handle disposed opposite the roller, i.e., at the back of the device.

The system is used by maneuvering the device free-hand, i.e., without the aid of a support or a guide, since the devices are designed to be used in space, far from any element or object that might impede the inexact movements of the user.

These devices have therefore proven to be completely unsuitable for precision work of the kind demanded by many finishing jobs in the construction industry: wall, ceiling and floor construction, roof framing and sheathing, painting, decorating, carpet-laying, etc.

The instant invention offers a novel approach for the application of strip material that enables even non-professional users to do precision work. To this end, the invention concerns a system comprising, on the one hand, a dispensing device, and on the other hand, at least one roll of strip of great length having a central opening optionally associated with a hub or a core, said system being provided with means for guiding an unwound free end of said strip out of the dispenser and applying it to a surface known as the “destination surface,” said device comprising:

a front portion comprising a location for at least one removable roll able to rotate relative to said front portion on a virtual axis transverse thereto,

an applying roller mounted to be rotatable transversely,

a maneuvering handle,

characterized in that the removable roll and the applying roller are associated with a position-maintaining mechanism designed to urge either the roll toward the applying roller or the applying roller toward the roll, so that these two elements are maintained constantly in tangential contact with each other.

Other characteristics of the invention will emerge from the following detailed description provided with reference to the appended drawing. The description and the drawing are, of course, given only as indicative and non-restrictive examples.

FIG. 1 is a schematic profile view of a system according to the invention in use.

FIG. 2 is a schematic profile view of an embodiment of the system according to the invention in which the base is equipped with a friction roller.

FIGS. 3 and 4 are schematic views of another embodiment of the system of the invention in which the base is mounted on an elastic leaf, and showing, respectively, the system being positioned against a wall and the same system in use.

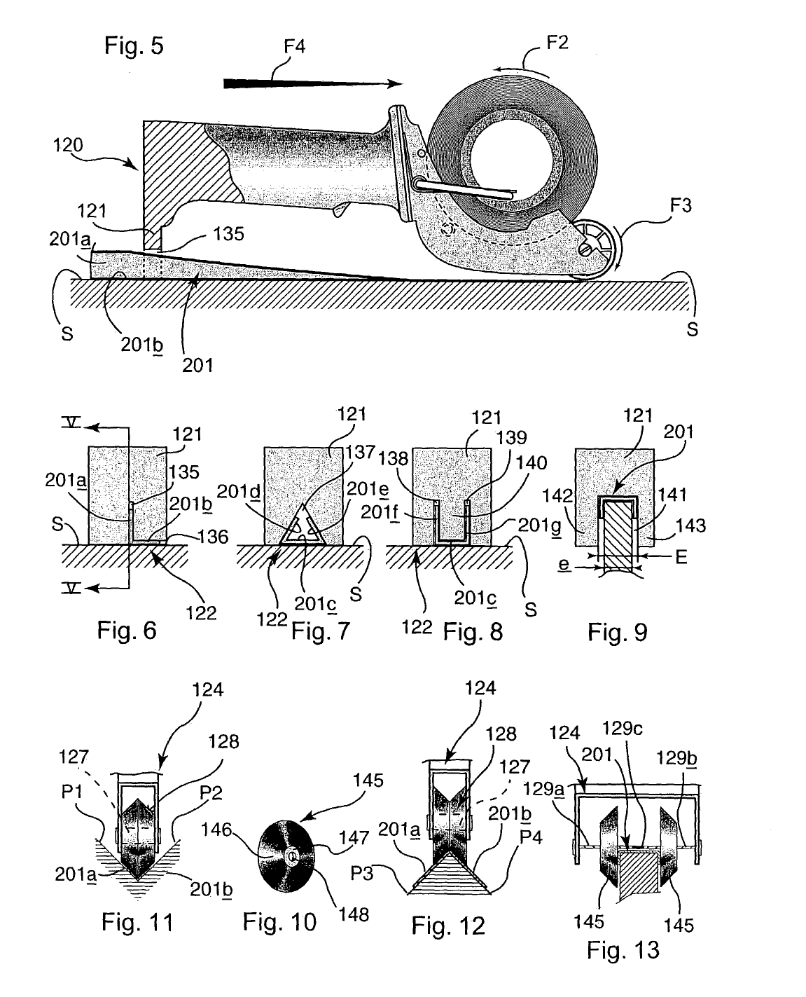

FIG. 5 is a schematic profile view of another embodiment of the system according to the invention in which this system comprises a former by which the strip to be applied can automatically be given a cross section of non-planar shape.

FIGS. 6 to 9 are schematic views showing variants shapes of the former.

FIG. 10 is a schematic perspective view of a truncated-cone-shaped disk having an apex angle of 45° and constituting half of a friction roller designed to assist in the shaping of the strip to be applied.

FIG. 11 is a schematic cross-sectional view depicting a friction roller formed by assembling two opposite disks by their large bases.

FIG. 12 is a schematic cross-sectional view depicting a friction roller formed by assembling two opposite disks by their small bases.

FIG. 13 is a schematic cross-sectional view depicting two truncated-cone-shaped guiding parts spaced apart by an adjustable distance so that the device can be used to apply either a strip or a rail or a guide to the edge of a panel.

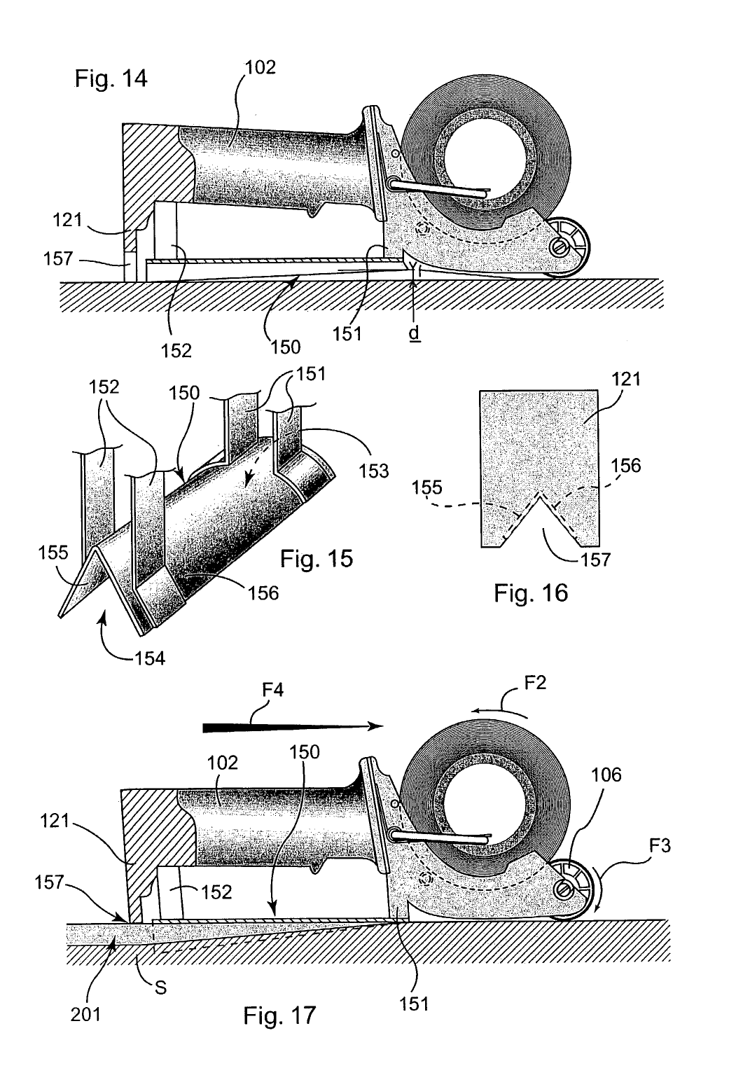

FIG. 14 is a schematic profile view of another embodiment of a system according to the invention in which the former comprises a guide jig.

FIG. 15 is a partial schematic view depicting the jig of the system of FIG. 14.

FIG. 16 is a schematic view showing the shape of the former matching the profile of the jig.

FIG. 17 is a schematic profile view of the system of FIG. 14 in use.

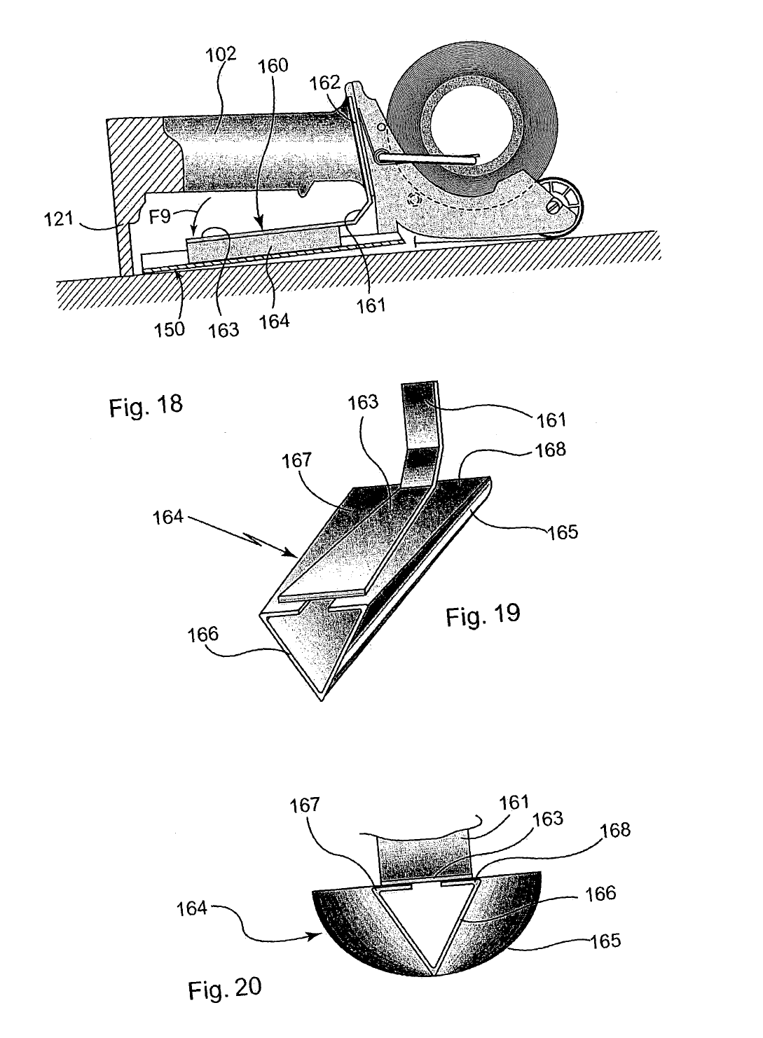

FIG. 18 is a schematic profile view of another embodiment of the system according to the invention in which the former comprises a guide trough, here associated with a pressing device for exerting pressure on the strip to be applied as it passes through said trough.

FIG. 19 is a partial schematic view showing the pressing device of the system of FIG. 18.

FIG. 20 is a partial schematic front view of the pressing device of FIG. 19, whose cross section varies from one of its ends to the other.

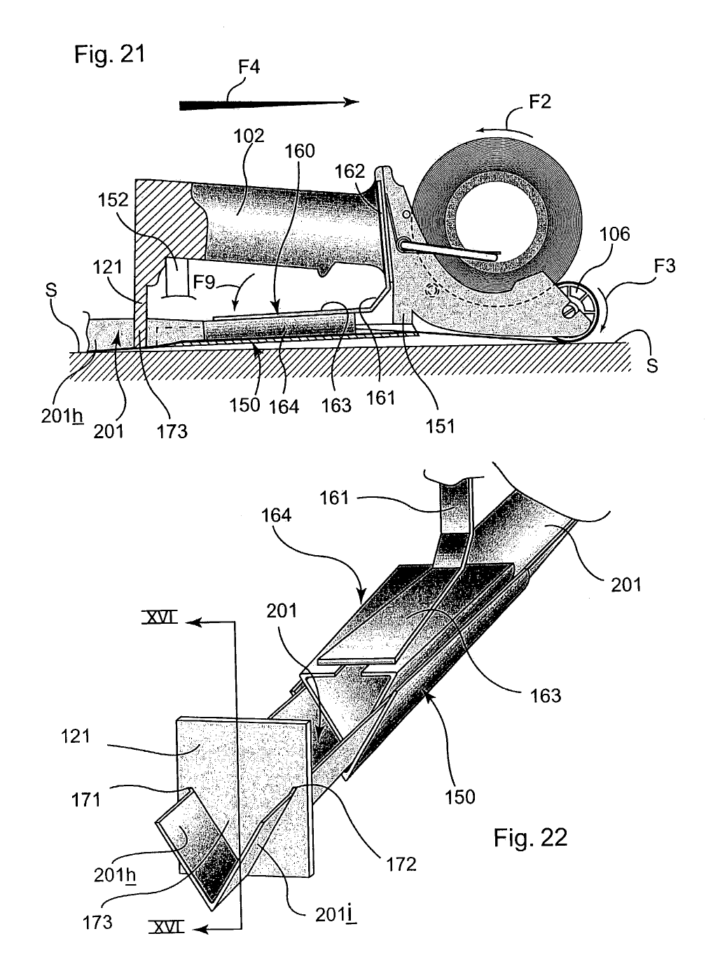

FIG. 21 is a schematic profile view showing the system of FIG. 18 in use.

FIG. 22 is a partial schematic perspective view depicting the passage of the strip to be applied into the trough, to the bottom of which it is applied by the pressing device.

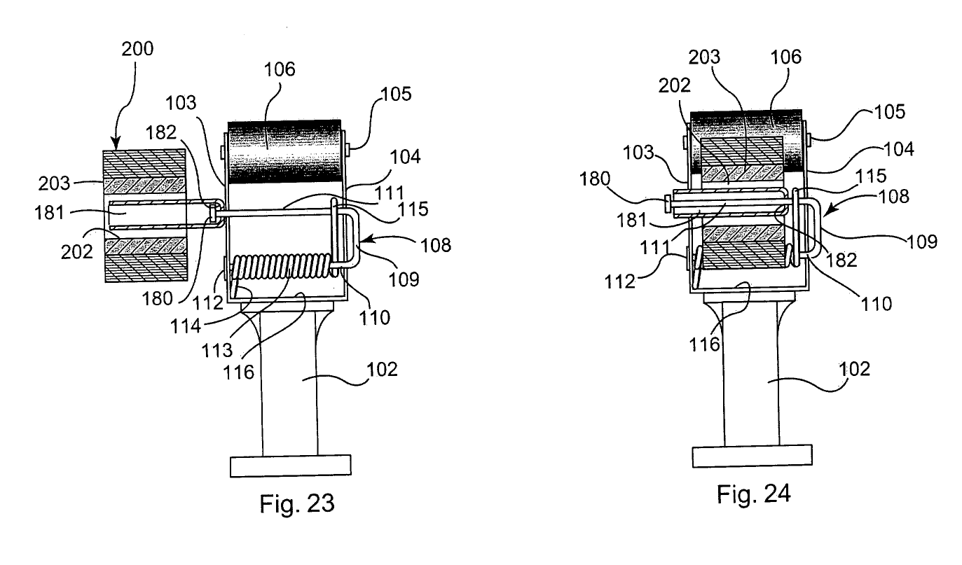

FIGS. 23 and 24 are schematic views depicting an embodiment of the invention in which the system includes a device making it easier to mount a roll of to-be-applied strip in its location.

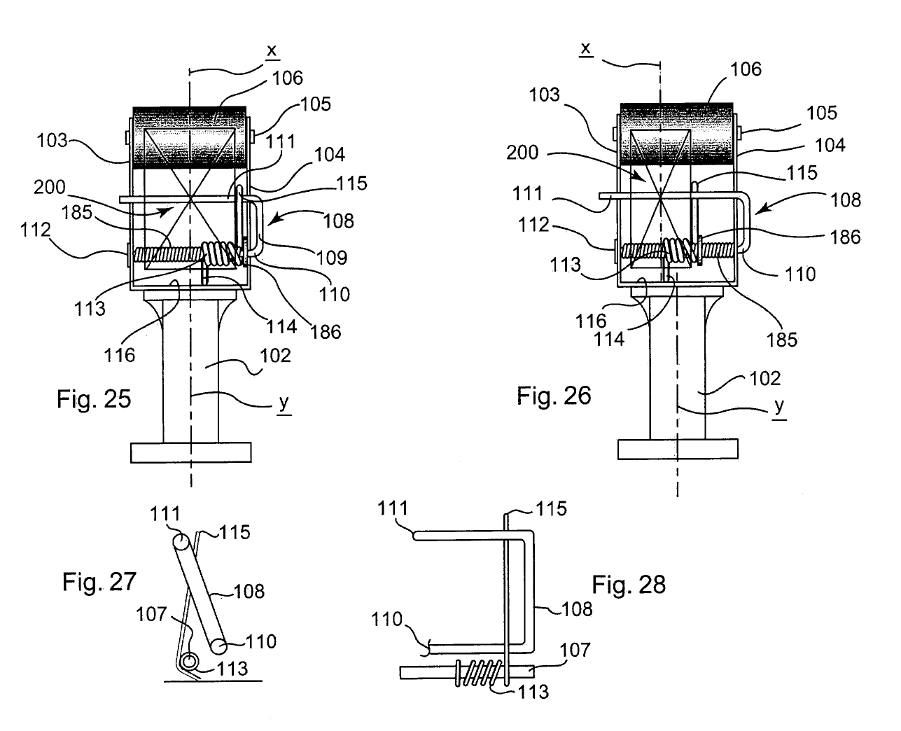

FIGS. 25 and 26 are two schematic views depicting an embodiment of the invention in which the system includes means for maintaining roils of to-be-applied strip of different widths, said means including a pressure spring engaged on a pin that is a part of said means.

FIGS. 27 and 28 are two schematic views depicting a variant in which the pressure spring is engaged on a cylinder external to the position-maintaining means.

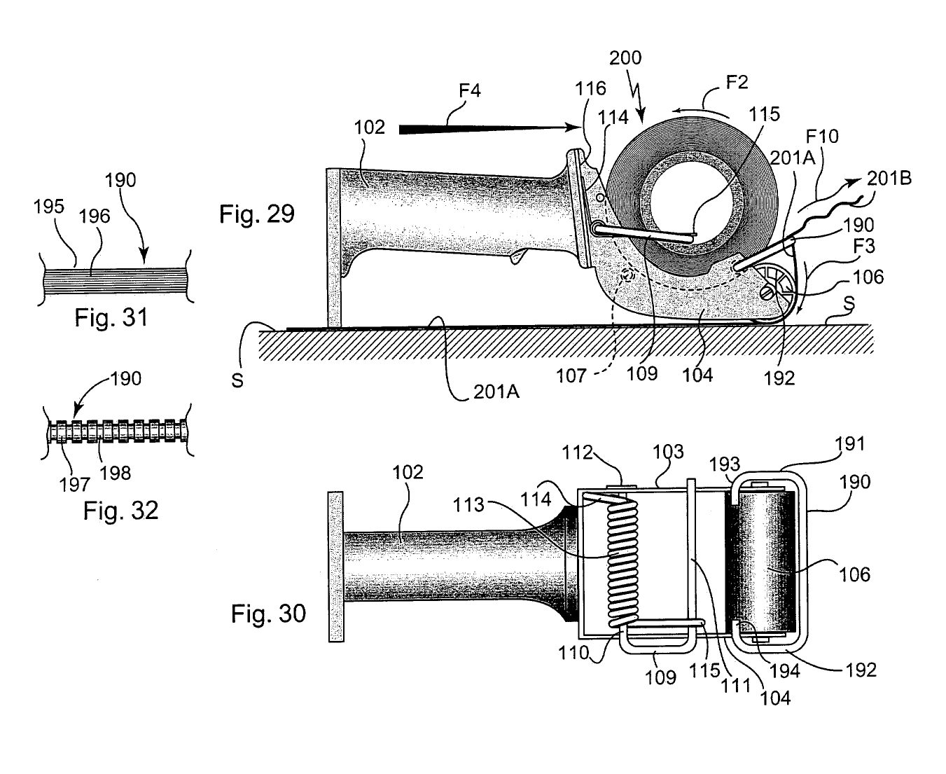

FIGS. 29 and 30 are two schematic views depicting an embodiment of the invention in which the system permits the use of a roll of strip having two distinct layers that must be separated by means of a bar before one of them is applied to a destination surface.

FIGS. 31 and 32 are two partial schematic views of two examples of the surface condition of the bar for separating the two layers of ribbon.

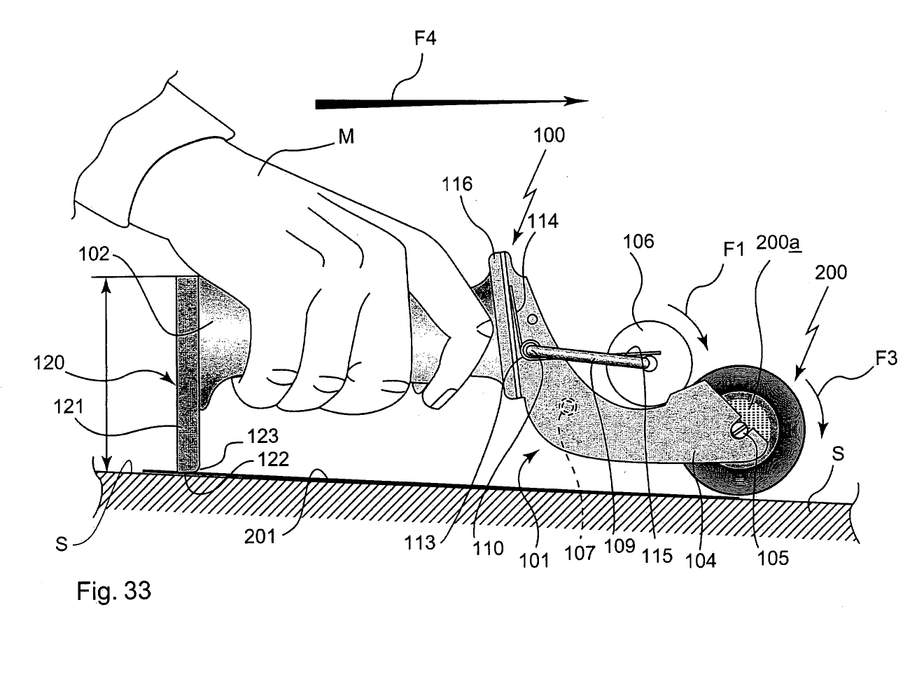

FIG. 33 is a view analogous to FIG. 1 and depicting an embodiment of the invention according to which the roll is disposed at the very front of the device and the applying roller is placed behind and above the roll.

Referring to the drawing, and more particularly to FIG. 1, it can be seen that a system according to the invention comprises, on the one hand, a device 100, and on the other hand, a roll 200 of strip 201 of great length.

Here, the example chosen is that of a strip wound upon itself into a large number of turns about a broad central opening 202 partially occupied by a core 203, for example of cardboard.

Device 100 is formed of a front portion 101 and a rear handle 102 by which the device can be maneuvered by a user, whose hand M has been depicted.

Front portion 101 is formed here of two parallel lateral covers 103 and 104 defining an axial space in which roll 200 is to be placed, and the width of this space, i.e., the spacing between the two covers 103 and 104, is dimensioned to enable a roll of greater or lesser width to be disposed in said space.

The two covers 103 and 104 serve as a support, on the one hand, for a rotatably mounted transverse pivot 105 carrying an applying roller 106 disposed at the end of front portion 101, and on the other hand, behind said roller 106, a cylinder 107, also transverse, mounted so as to pivot freely and serving as a support for the roll 200, which rests both on applying roller 106 and on support cylinder 107.

FIGS. 1 to 30 depict an embodiment of the invention in which the applying roller 106 is disposed at the very front of the device and removable roll 200 is placed behind and above said roller 106.

Thus, roll 200 rests both on leg 110 and on applying roller 106 when its diameter is large. When a great length of strip 201 has been drawn off, the diameter of roll 200 has decreased and it then rests on support cylinder 107 and on applying roller 106. In other words, roll 200 always remains in contact with roller 106, regardless of the diameter that it has, depending on the length of strip used up.

FIG. 33, which will be described in detail subsequently herein, shows another embodiment of the invention in which the removable roll 200 is disposed at the very front of the device and the applying roller 106 is placed behind and above the roll 200.

In both cases, these two elements, the removable roll 200 and the applying roller 106, are and remain bearing against and in tangential contact with each other to ensure that the strip is applied to the application surface under even and constant tension.

The front portion comprises at least one pivotably mounted transverse cylinder, serving as a support for the roll so that it rests both on the support cylinder and on the applying roller when disposed therebehind.

The device comprises a position-maintaining mechanism constituted by a rod bent into a U shape to comprise a lateral web and two transverse legs, the first of the two legs being mounted pivotably with respect to the support and the second intended to be disposed in the central portion either of the roll or of the applying roller, a spring being engaged with the bent rod to urge it constantly toward its position in which the second leg bears against the central portion either of the roll or of the applying roller.

The position-maintaining mechanism includes a bar 108 bent into a U shape to comprise a web 109 and two parallel legs 110 and 111.

Leg 110 is freely engaged in two aligned holes provided in covers 103 and 104, and is locked in axial translation by a catch 112 that is attached to it [and is disposed] on the outside of cover 103 (FIGS. 22, 23, 24, 25 and 27).

Engaged on this same leg 110 is a coil spring 113 having two straight ends 114 and 115 disposed in abutment with the back 116 of front portion 101 and against leg 111 after spring 113 has been placed in tension, thereby causing leg 111 to be urged constantly downward as indicated by arrow F1.

It will be appreciated that leg 111 thus bears forcefully against the inner face of core 203 and maintains the entirety of roll 200 pressed tangentially against applying roller 106 and against support cylinder 107, the foregoing assembly constituting a dispenser for the roll 200 and the distribution of the strip 201. Front portion 101 of device 100 is completely open at the front and thus defines a free space between the location of roll 200 and the front of applying roller 106. According to the invention, the strip 201 is unwound for a given length to form a free end, which is guided in the direction of arrows F2 and F3 from the bottom of roll 200 to the front of applying roller 106, which it surrounds in an arc extending from the top of roller 106 to the lower generatrix thereof.

After bringing the free end of the strip 201 into a position below and in front of applying roller 106, the user holds the handle 102 in one hand M and pushes the device in the direction of arrow F4, causing this free end to be applied to the destination surface S, become affixed thereto, and unwind for as long as the user pushes the device, which passes above the already affixed free end.

It could be provided that the free end unwinds from the top of the roll 200 and descends directly toward the front of applying roller 106, but this arrangement has the disadvantage that the roll is unstable because it is subjected to a forward tractive force, which can cause it to tilt despite the retaining action of the spring 113 pressing leg 11 against central opening 202 and thus tending to hold roll 200 in place. Furthermore, this arrangement is incompatible with strips having an adhesive side serving to affix the strip to the destination surface S, since this adhesive side would have to pass against the applying roller, which is impossible, of course, since it would remain stuck thereto and would not be able to leave it to be applied to surface S.

It will be noted that the free end passes over the front of applying roller 106 rather than the back, in contrast to the structure of existing devices, and that consequently the strip 201 affixed to the destination surface S extends beneath the device as it travels in the direction of arrow F4, in vertical alignment with the handle 102.

This kinematics, combined with the fact that roll 200 bears constantly and evenly against applying roller 106, permits a number of novel functions that will be described hereinbelow, and that enable the user's movements to be more efficient and precise, so that the resulting work is of much better quality that it is at present, and is even different in nature, since jobs that are impossible to perform with known devices can be accomplished. The device can therefore be used for new applications, particularly in the construction field, making it possible to apply strip materials of all kinds, including relatively rigid ones such as metal or plastic strip.

Thus, according to a characteristic of the invention, the device comprises a base 120 which here is integral to the handle 102 and secured to the back thereof. This base 120 can be divided into two distinct functional parts: an active portion, which is designed to be in contact with the strip 201 after it has been applied to the destination surface S by roller 106, and a strut that is integral to the device and bears the active portion.

In FIG. 1, the strut 121 extends for the entire height H, measured between the top of the handle 102 and a plane corresponding to the location of the destination surface S when the applying roller 106 is placed thereon with the strip 201 interposed and when the handle 102 is substantially parallel to said destination surface S.

Here, the active portion is the transverse bottom 122 of strut 121, said bottom comprising a rounded or at least oblique fillet over the entire length of the transverse edge of the strut 121 to facilitate the unobstructed passage of the strip 201 under the active portion 122 without any excessive friction that might damage the strip 201.

It will be understood that when the device is moved in the direction of arrow F4, strip 201 applied to destination surface S by roller 106 is pressed upon by the active portion 122 of base 120 to a degree that depends on the pressure exerted by the user on the handle 102, somewhat in the manner of a person doing ironing.

The strip 201 is therefore applied very exactly, and if it is adhesive tape, maximum adhesion is obtained, any wrinkle or air pocket being removed by the strong pressure exerted perpendicular to the destination surface S.

According to a characteristic of the invention, roller 106 is positioned at the front end of the device so that the roll 200 having the maximum diameter is always set back from roller 106 by a distance D. This arrangement makes it possible to apply the strip 201 in maximum proximity to a wall angle, for example, since no part of the system gets in the way of the advancement of the device, the forwardmost element being the portion of the strip 201 disposed against the roller 106.

It will also be noted in FIG. 1 that the device has no built-in cutting means, since the precision work for which it is intended requires clean cutting of the strip that can be achieved only with the use of a separate tool with a very sharp blade, such as a knife, a razor blade or the like.

Turning now to FIG. 2, the drawing shows a more elaborated variant of the base 120, whose strut 121 is shorter than that of FIG. 1, since it receives at its bottom end a clevis 124 whose two ends 125 and 126 are joined together by a pin 127 for a roller 128 having a straight generatrix, i.e., a cylindrical roller, mounted to be able to rotate freely and constituting the active element of base 120.

The integrity of the strip 201 is thereby assured despite the pressure exerted on it perpendicular to its plane, roller 128 traveling in the direction of arrows F5 over the stationary strip 201 when the device is moved in the direction of arrow F4.

Cylindrical roller 128 is advantageously of the same width as applying roller 106, but its width can also be coordinated with that of the strip 201, it either having the same width as the strip so as to distribute over the entire area thereof the pressure exerted by the user, or having a lesser width so that the pressure exerted is applied to only a portion of the strip 201, particularly its central portion.

Coordinating the width of roller 128 with that of strip 201 implies that the device will receive only one type of strip, or, alternatively, that the roller 128 is removable so as to be interchangeable with other, similar rollers of various widths.

However, a description will be provided subsequently herein of a particular embodiment in which the roller 128 can also have a non-flat shape very different from that of a cylinder, particularly coordinated with the characteristics of destination surface S.

Thus, for example, ends 125 and 126 can be prolonged well beyond the lower generatrix of roller 128 to constitute lateral guides intended to move in parallel opposite the large sides of a panel on the edge of which roller 128 is to move, the intention being to apply the strip 201 to said edge and against said large sides, the guides assisting in laying the bent margins of the strip 201 thereagainst.

Of course, the lateral guides can be formed of elements other than the clevis ends, and in particular attached thereto, directly or with the interposition of positioning washers or shims.

FIGS. 3 and 4 show a particular embodiment of the invention according to which the device comprises a base 130 disposed in vertical alignment with the mid-portion of handle 102.

The strut of base 130 is constituted by a flexible leaf 131, one end 132 of which is inserted and fastened between handle 102 and front portion 101, and which is shaped to extend obliquely under handle 102 so as to be inclined slightly with respect to the horizontal axis of said handle 102.

Flexible leaf 131 is cambered so that its end 133 opposite end 132 straightens out at an angle such that a shoe 134 fastened under this end 133 is substantially parallel to destination surface S, so as to apply even pressure to the strip 201. This embodiment is depicted on a device used to apply strip 201 to a vertical destination surface S, such as a residential wall, for example.

In FIG. 3, it can be seen that the device is laid against the surface S via roller 106, after a small length of strip 201 has been pulled out to create an unwound end. Virtual plane P, containing the lower generatrix of roller 106 and the bottom side 122 of strut 121, is oblique, and the inclination of elastic leaf 131 is such that shoe 134 is located well beyond this plane P.

The user then pivots the device in the direction of arrow F6 so that the bottom side of strut 121 brought to bear against surface S with the interposition of strip 201.

This being done, shoe 134 encounters the unwound end of strip 201 and flattens it against surface S, and as the device continues to pivot, elastic leaf 131 is pushed back in the direction of arrow F7 and remains in abutment against surface S, bending until the planar bottom of shoe 134 is within plane P, which position is depicted in phantom lines in FIG. 3.

The “memory” of elastic leaf 131 has the effect of causing it to constantly urge shoe 134 to bear against strip 201 and thus against destination surface S, in the direction of arrow F8.

To facilitate the commencement of the work, the user can manually flatten the unwound end of strip 201 against surface S so that the strip 201 is already flattened out and smoothed when the base 120 is placed thereon.

The user can then move the device in the direction of arrow F4, upwardly in this case, as shown in FIG. 4, the shoe 134 smoothing the strip 201 just before the base 120 lays it forcefully against surface S.

To keep the shoe 134 from catching on wrinkles in the strip 201, the front generatrix of shoe 134 comprises either a rounded fillet 134a or a simple bevel (not shown).

The foregoing description has been of a flat shoe 134 designed to apply a strip 201 which itself is flat to a destination surface S that is also planar.

However, the bottom of the shoe 134 can also be given a shape coordinated with that of a non-planar destination surface, which would be the case, for example, with a salient or a reentrant angle. The bottom face of shoe 134 is then concave or convex to adapt it to the site where the strip 201 is to be applied.

Naturally, it is not possible to provide the same device with a base 130 and a base 120 equipped with a roller 128, that is, to combine the embodiments of FIG. 2 and FIG. 3.

The shoe 134 can be of a rigid or slightly flexible material, for example of a hard material covered with a sole made of elastomer or a synthetic material such as polytetrafluoroethylene, known commercially under the registered name “Teflon,” which has the property of possessing a very low coefficient of friction while at the same time being rigid.

For obvious reasons, the strip 201 is wound flat and the preceding description implies that it is also extended flat onto surface S.

However, there are cases where it is desirable to apply the strip 201 to surfaces S that are more complex than a simple planar surface, especially in the construction industry, where numerous joints between adjacent surfaces are used that are not always exactly aligned and frequently are even offset angularly, particularly forming a salient or a reentrant angle, as is the case with two walls, a wall and a ceiling, or a wall and a floor.

It can also be necessary to place strip on the edge of a panel and fold it over onto one or both faces of the panel adjacent said edge, or, further, on a rail or a sliding or rolling guide, etc.

In the case of an angle, the strip 201 must be applied in an “L” shape, and in the case of an edge or slot it must be applied in a “U” shape.

Some existing strip materials are premarked with one or more longitudinal lines to make it easier to fold the strip over its entire length as it is put in place. This operation is currently done by hand in a discontinuous manner, that is, the user cuts a given length of a strip stored on a roll and applies the independent segment so obtained by pressing it manually into place in such fashion that it bends and takes on the desired cross section by being “molded” to the destination surface, which serves as a former.

By contrast thereto, the invention permits the continuous application of a strip that is preformed automatically by the device itself.

Referring to FIG. 5, it can be seen that the invention makes it possible to equip the device with a former whose purpose is to give a strip 201 a different cross section from that which it has naturally when still on the roll.

In FIGS. 5 and 6, strut 121 of the base 120 can be seen to comprise a slit 135 through which the user passes the unwound end of strip 201 at the beginning of the procedure, after having folded it lengthwise to give it, in this instance, an L-shaped cross section.

It will be understood that as the device advances, strip 201 arrives flat and turns up on one side to form a flap 201a perpendicular to a second flap 201b, which remains parallel to the surface S and is applied thereagainst.

The strip 201 can be relatively thick, especially in the case of paper/metal composites, and to ensure that the device remains exactly perpendicular, the strut 121 comprises a recess 136 over a height substantially equal to the thickness of the strip 201, which further assists in forming the strip 201 into a cross-sectional L shape. In FIG. 6, it can be seen that this enables the strut 121 to be exactly perpendicular to the destination surface S, the left-hand portion of active portion 122 resting directly on the surface S and the right-hand portion, forming the recess 136, resting on flap 201b of strip 201.

Other shapes are feasible, however, depending on the cross section that is to be imparted to the strip 201.

In FIG. 7, strut 121 has a single, triangular opening whose sides constrain the strip 201 to turn up at its two lateral margins, to comprise, once past the former, a base 201e parallel to the surface S and applied thereagainst and two flaps 201d and 201e, which together give the strip 201 a pinched U-shaped cross section.

In FIG. 8, strut 121 has two parallel slots 138 and 139 that define between them a small panel 140 whose height is smaller than that of strut 121 per se, by a value substantially equal to the thickness of strip 201, the purpose being, as in the case of FIG. 6, to ensure exact perpendicularity to destination surface S, the left and right lateral portions of active portion 122 resting directly on surface S while the central portion that is the base of small panel 140 rests on strip 201, which has the same base 201e parallel to surface S and applied thereagainst, as well as two flaps 201f and 201g that together give strip 201 a normal U-shaped cross section.

FIG. 9 shows the case in which strip 201 is to be applied to the edge of a panel with the two margins of said strip folded down on both sides of the edge, i.e., over the two large faces of the panel.

To this end, strut 121 has a broad, rectangular, central recess 141 defining two lateral struts 142 and 143 whose spacing E is greater than the thickness e of the panel PL to whose edge strip 201 is to be applied, and whose depth is preferably greater than the height of the folded-down margins of strip 201.

FIG. 9 shows that the strip 201 has been folded lengthwise into an inverted U and is pressed against the upper edge of the panel PL by the central edge of the recess 141. Also illustrated here is the case in which the spacing E is greater than the thickness e by a value equal to twice the thickness of the strip 201, so that the two folded-down margins as well are brought to bear against the large faces of the panel PL by the lateral edges of recess 141.

Unless the device is always used for panels PL of the same thickness e, the former 121 must be interchangeable with other, similar formers having recesses 141 of different widths, coordinated with the different thicknesses e of the panels PL.

FIGS. 10 to 12 illustrate a particular embodiment of the former in which roller 128 does not have a straight generatrix, contrary to that depicted in FIG. 3, which was commented on hereinabove in explaining that the roller 128 having a straight generatrix is designed to roll over the strip 201 laid flat on a destination surface S which itself is planar.

In FIG. 11, roller 128 is defined by a generatrix having a salient angle of 90° and is designed to be placed at the intersection of two walls P1 and P2, strip 201 having its two flaps 201a and 201b at a 90° angle with respect to each other as in the case of FIG. 6, but here they are depicted in a V rather than an L shape.

In FIG. 12, roller 128 is defined by a generatrix having a reentrant angle of 90° and is designed to be placed at the salient angle of two walls P3 and P4, the strip 201 having its two flaps 201a and 201b at a 90° angle with respect to each other as in the case of FIG. 6, but here they are depicted in an inverted V rather than an L shape.

It is also feasible to couple two rollers 128 placed one behind the other, which makes it possible to shape the strip 201 in two steps and thus to perform this operation in a gradual manner, which is particularly advantageous with a relatively fragile strip such as one made of glass fibers.

Such rollers having a 90° angle are widely used, of course, and can be realized so that each is a single part removably mounted in the clevis 124, which enables the user to select the roller he needs according to whether it is to be placed flat (FIG. 3), inserted into a reentrant angle (FIG. 11) or placed over a salient angle (FIG. 12). It is also feasible to use two identical parts 145, one of which is depicted in FIG. 10, formed of a truncated-cone-shaped volume having a large base 146 and a small base 147 of different diameters, joined by a slope with an angle at the apex of 45°, with an axial hole 148 passing through this part 145.

Thus, to form roller 128 of FIG. 11, two parts 145 are placed flatly one against the other by their large bases 146, whereas to form roller 128 of FIG. 12, the two parts 145 are placed flatly one against the other by their small bases 147. The two parts 145 are then coupled together by pin 127 engaged in the two aligned holes 148.

To permit this assembly, parts 145 obviously must be removable individually from clevis 124, and rotating pin 127 must itself be removable to permit the installation and removal of parts 145. The means by which pin 127 is fastened to clevis 124 are of any known type and are within the immediate reach of one skilled in the art, and thus will not be described in detail here.

FIG. 13 depicts an assembly comprising a wider clevis 124 than that of FIGS. 11 and 12 and serving as a support for two threaded rods 129a and 129b joined end to end by a weld 129c and mounted so as to rotate freely, on which are engaged two parts 145 whose relative spacing is adjusted by immobilizing them and turning the rods 129a and 129 [sic], causing the two parts 145 to move simultaneously in the opposite direction. Thus, the two parts 145 can be disposed at the desired (and adjustable) spacing on both sides of a panel P5 which serves as a guide for the movement of the device during the application of strip 201 to the edge of panel P5 constituting the destination surface. This structure ensures exact guidance of the strip 201 over narrow surfaces, the movement obtained still being precisely parallel to the edges of the destination surface. It also makes it possible to apply a rail or border to the edge of panel P5 owing to the lateral maintenance and exact guidance of the rail or the border as it is being laid, which prevents any lateral offset.

The same device must be usable with different kinds of strip 201, and the former itself must therefore be adaptable to different cross sections of said strip.

In the foregoing examples, the former is a transverse plate 121 that merges with the base 120, and the drawings depict said base 120 as fixed.

Actually, however, it can be provided that the base 120 is removable to permit the universal use of the device, including without a base, and it can likewise be provided that the former is a removable plate 121, i.e. an interchangeable one, to make it possible to choose a given type of former according to the strip 201 being used and the cross section to be obtained when it is applied to the destination surface S.

It will be appreciated that a former constituted by a plate penetrated by one or more passages behaves in the manner of a die, and that this passage or these passages can be of different shapes and sizes, depending on the cross section desired for the strip 201 beyond the former, which will also depend on the characteristics of the strip 201: width, thickness, rigidity, flexibility, etc.

The thickest and most rigid strips 201 can strongly resist the action of the former, especially when they are not premarked for folding, and this disadvantage can be greatly attenuated by means of a particular embodiment of the invention that is illustrated by two variants depicted respectively in FIGS. 14 to 17 and in FIGS. 1 to 22, to which reference should now be had.

According to the embodiment of FIGS. 14 to 17, the former comprises, or consists of, a longitudinal jig 150 that is secured under the handle 102 by supports 151 at the front and 152 at the back, and whose ends constitute an entrance 153 just behind the roller 106 and an exit 154 just in front of the former 121 described earlier hereinabove.

Thus, strip 201 is inserted under jig 150 via entrance 153 and leaves it via exit 154, opposite the former.

In the example shown, the previously described former is present and is still constituted by the strut 121 of base 120, so that the user inserts the free end of strip 201 into this former in the previously described manner, after engaging it under the jig 150, which helps cause it to change shape in order to facilitate the final action of transverse former 121.

When the strip 201 is very flexible the action of jig 150 may be sufficient, in which case the transverse former can be dispensed with, which is the case when base 120 also is not present. But if base 120 is kept, it must afford unobstructed passage to the strip 201 with the cross section that it has after taking on the internal shape of jig 150.

The device can, of course, include a transverse former and no jig 150, as described with reference to FIGS. 5 to 9.

On the other hand, when the strip 201 is difficult to shape, the jig 150 aids in this shaping, and to this end it is helpful to give it different cross sections at the entrance and at the exit, which can be achieved by means of aligned arches instead of a continuous, elongated jig.

However, an effective approach is to give the jig 150 a gradually varying cross section, as is clearly evident in FIG. 15, which shows an entrance 153 with a curved cross section having a relatively large radius of curvature, whereas the exit 154 has an inverted-V-shaped cross section, the side walls of jig 150 drawing steadily closer together to terminate in two planar convergent walls 155 and 156.

To enable the strip 201 to pass through strut 121 after it has been shaped into an inverted V, said strut 121 has a throughpassing opening whose shapes and dimensions provide unobstructed passage.

However, said opening can also be made to serve as a former whose cross section is either identical to that of the exit 154, or slightly different therefrom in order to prolong the shaping of the strip 201 beyond the former.

Thus, in FIG. 16, it can be seen that provided in strut 121 is a triangular recess 157 having the same shapes and dimensions as opening 154 of jig 150, as indicated by the phantom lines marking the location of walls 155 and 156, behind strut 121, in the prolongation of the edges of recess 157.

FIG. 17 shows that when the system is in use the device is moved in the direction of arrow F4, strip 201 unwinds, passes over applying roller 106, passes into jig 150, passes through strut 121, and ultimately exits with an inverted V-shaped cross section resulting from its passage through triangular recess 157.

Such a shape is useful for placing strip 201 on a salient angle, for example, the two convergent flaps of the strip 201 being able to bend slightly so as to lie exactly against the external face of the salient angle.

It can be seen in FIG. 14 that the jig 150 is inclined slightly from front to back, so that the bottom edges are distinctly above destination surface S in vertical alignment with its entrance 153. The measured distance d between the bottom of jig 150 at its entrance 153 and the destination surface S is relatively small, but sufficient so that the front edge of jig 150 does not impede the advancement of the device in the direction of arrow F4, since this edge must be prevented from acting as a plough and damaging the strip 201 being applied to the destination surface S, given that jig 150 is traveling just above this stationary strip 201.

When the strip 201 is fine or elastic and does not retain the shape it is given, it may flatten out again after being folded by the former, in which case this folding action by jig 150 has no utility.

Some strips, such as paper/metal composites, are very robust and readily retain the folded shape imparted to them by the former, but the force that must be applied is considerable, and the mere action of guiding the jig 150, whether or not combined with the transverse former 121, may not be sufficient and [this insufficiency] can be compensated for only by effort on the part of the user.

According to the embodiment of FIGS. 18 to 22, the jig is inverted and assumes the shape of a trough 150, in which a pressing device is engaged downwardly so that the strip is grasped between the bottom of the trough 150 and the outside of the pressing device, thereby ensuring the deformation of the strip 201 even if it resistant in nature.

In FIG. 18, pressing device 160 can be seen to comprise a flexible leaf 161, one end 162 of which is inserted and fastened between handle 102 and front portion 101, and which is shaped to extend obliquely under handle 102 so as to be inclined slightly with respect to the horizontal axis of said handle 102.

Flexible leaf 161 is cambered so that its end 163 opposite end 162 straightens out at an angle such that a template 164 secured under said end 163 and having outer shapes that are complementary to the inner shapes of the trough 150 is placed therein, practically in contact with its walls.

The elasticity of blade 161 urges it constantly downward, i.e. toward the bottom of the trough, in the direction of arrow F9.

Trough 150 having an entrance cross section that is a broad, fairly flat curve and a V-shaped, triangular exit cross section, template 164 has a convex outer shape identical to the concave shape of trough 150, so that strip 201 inserted between trough 150, constituting a die, and template 164, constituting a punch, is forced to conform to the cross section of the space created by its own passage through trough 150, lifting template 164, which constantly pushes the strip 201 against the inner face of the trough in the direction of arrow F9.

With these measures, the strip 201 is constrained to deform under the pressure exerted by the template 164, and the magnitude of this pressure depends on the intensity of the spring power developed by flexible leaf 161.

The template 164 is a rigid, convex body, for example molded of synthetic material or stamped from and bent in a metal plate, which has a continuous outer surface that is symmetrical with respect to a longitudinal axis.

Both of its ends are open and the contour of the back portion 165 is curved, whereas the contour of the front portion 166 is triangular.

When the template 164 has been made from a bent metal plate (as shown in the drawing), it has two lateral returns 167 and 168 to which flexible leaf 161 is attached by its end 163.

To use this system, the user pulls out a small length of strip 201, passes the free end in front of applying roller 106, inserts the end of strip 201 into trough 150 after raising template 164, and then engages said end in the opening of strut 121.

This arrangement is depicted in FIGS. 21 and 22, and it should be noted that contrary to what has been described and shown hereinabove with respect to FIGS. 14 to 17 (more particularly FIG. 16), strut 121 does not have a completely open recess 157 passing through it, but rather, two diverging slits 171 and 172 defining between them a solid portion 173.

This structure is more constraining to the shaped strip 201, since in this case the strip is not left any possibility of malforming on leaving the device, and in this example it can be seen that after being shaped the strip 201 has two diverging flaps 201h and 201j.

The device can be designed to receive rolls all having the same type of core, which is the case when a spindle and a clamping and centering pin are provided.

However, it is more advantageous to provide means enabling the device to receive rolls 200 of more than one diameter, of more than one width and having different cores, or even no core at all.

This is the approach that has been chosen here, said means having been set forth at the beginning of this description and essentially comprising a bar 108 bent into a U shape to comprise a web 109 and two parallel legs 110 and 111, leg 110 receiving a coil spring 113 whose effect is to urge leg 111 constantly downward (arrow F1).

According to the invention, the installation of the roll 200 is facilitated, especially when it has large dimensions in terms of diameter and/or width, by means that will now be described with reference to FIGS. 23 and 24.

The free end of leg 111 bears a stop 180 and is surrounded by a tube 181 that is able to pivot freely on itself and that is also able to slide freely along leg 111 until it encounters stop 180 by a transverse portion 182 which it comprises at its end engaged on leg 111. In this extreme position, tube 181 extends well past the contour of the device considered from its left side, as depicted in FIG. 23.

To put roll 200 in its location, the user slides tube 181 toward the outside of that location (FIG. 23) and simultaneously raises leg 111 in opposition to spring 113; he then engages roll 200 so as to pass tube 181 into central opening 202 in core 203; he then pushes the assembly composed of roll 200 and tube 181 back transversely with respect to the device, tube 181 sliding freely to come to a stop when it abuts end 115 of spring 113, thus covering practically all of leg 111. Thus, roll 200 is in place, the user allows leg 111 and the tube 181 covering it to rest against core 203 inside central opening 202, the roll being maintained bearing against applying roller 106 and against support roller 107 (FIG. 24).

The foregoing structure makes the device more convenient to use, but it also has a function of interest in that it permits the use of rolls that are so wide as to extend slightly past the lateral contour of the device, thus making it possible to apply the strip 201 to a lateral wall, since the device itself is set back from the edge of the roll and does not constitute a troublesome obstacle.

According to another characteristic of the invention, it is feasible to laterally adjust the exact position of a roll 200 the width of whose strip 201 than that of the assigned location of the roll, and thus smaller than that of the applying roller 106.

FIGS. 25 and 26 illustrate a structure of this type.

It will be noted that spring 113 is much shorter than the leg 110 on which it is engaged, so that its position along said leg 110 can be adjusted by means of an adjusting mechanism.

For purposes of this adjustment, leg 110 is provided with a thread 185 over its entire length located between the two covers 103 and 104 and receives a nut 186 which mates with the thread 185 and whose periphery is knurled so that the user can easily grasp it between two fingers in order to tighten and loosen it.

Nut 186 is connected to spring 113 in the sense that it bears against it. These two elements can be attached to each other, in which case spring 113 can move by simple translation along leg 110 and nut 186 can turn with respect to thread 185 and also progress along said leg 110.

It will be appreciated that thread 185 and nut 186 constitute a mechanism for adjusting the position of spring 113, since the latter, when nut 186 is tightened or loosened by hand, acts on nut 186 by direct contact with end 115, optionally with the interposition of a washer (not shown).

During the travel of spring 113 along leg 110, end 114 thereof slides transversely against the back side 116 of front portion 101 and end 115 thereof slides transversely along leg 111.

In FIG. 25, it can be seen that roll 200 is relatively wide, and nut 186 has therefore been acted upon so that it is disposed near cover 104 and end 115 of spring 113 is in abutment therewith, the roll, when installed from the side, coming into abutment by its lateral side with said end 115, its x-axis coinciding with the longitudinal y-axis of the device.

In FIG. 26 the roll 200 is relatively narrow, and nut 186 has been acted upon so that it is disposed in a position midway between covers 103 and 104, the desired position for roll 200 being such that its x-axis is shifted laterally toward cover 103, in which case said x-axis is offset from the y-axis of the device.

By virtue of this arrangement, which is characteristic of the invention, the user is able to adjust the lateral position of the of the roll 200 by prepositioning the end 115 of the spring 113 by means of the nut 186 and pushing the roll 200 sideways until its lateral side comes into abutment with that end 115.

The choice of this position depends on the work to be performed, which motivates not only a given width of roll 200, but also the exact position of its x-axis relative to the y-axis of the device.

According to a variant embodiment, spring 113 can be engaged, not on leg 110, but on a specific transverse rod or, alternatively, on retaining cylinder 107, as shown in FIGS. 27 and 28. The manner of operation of this structure is identical, mutatis mutandis, to that described hereinabove when spring 113 is engaged on leg 110.

FIGS. 29 to 32 illustrate a characteristic of the invention according to which the device can be used with strips having at least two distinct layers that must be separated before the strip can be applied to a destination surface.

This is the case, in particular, with tapes bearing a long-acting adhesive on only one side or on the two opposite sides of a single tape. Such tape is commonly referred to in practice as “single-sided” or “double-sided” tape, depending on whether a given tape has one or two sides coated with adhesive.

A long-acting adhesive is by definition active for a long period of time, that is, a period on the order of several months or even several years, provided that it is protected against evaporation, drying and oxidation.

When the tape is single-sided, a consequence of winding it into a spiral is that the adhesive side is placed in contact with the nonadhesive side, and the material of such a tape is selected so that the adhesive already applied to one side adheres very little to the other side, so that it is relatively easy to unwind the tape, whose turns separate from each other without excessive force.

When the tape is double-sided, simple winding is not possible because two adhesive sides would be placed in contact with each other and it would then be impossible to separate the turns. In this case, the adhesive tape and its protective strip are applied together and the latter is then removed, so as to leave the adhering tape in place and uncover the other, also adhesive side, thereby exposing, on the outside of the applied and adhering tape, a side that can be used to attach a separate element to the destination surface.

In the case of “single-sided” tape, the tape when new has two layers, one of which is the tape per se to be applied to the destination surface and the other of which is the protective strip.

When such a tape is to be applied to the destination surface, the protective strip must be pulled off so it can be removed.

To this end, the device of the invention comprises a bar 190 disposed transversely in the vicinity of applying roller 106, immediately thereabove, i.e., on the near side of the generatrix of this roller with which the tape is to make contact during the use of the device.

Before beginning to use the device, the user manually separates the two layers of tape 201, i.e., the tape per se 201A and the protective strip 201B, and passes tape 201A under the bar 190 and strip 201B over said bar 190 (FIG. 29).

The user then makes use of the device as described hereinabove, by pushing it in the direction of arrow F4, and tape 201A is applied to the destination surface S by its side coated with long-acting adhesive, the forcefulness of this action being greater, the more vigorously the applying roller 106 is pressed perpendicularly to destination surface S.

Bar 190 constrains tape 201A and protective strip 201B to separate, the former passing in front of and then beneath applying roller 106 in the direction of arrow F3, while the latter passes above bar 190 in the direction of arrow F10.

Bar 190 can be secured to the device by any known means; the means used here to illustrate the invention consists of a metal rod having a bent circular cross section so as to comprise two lateral legs 191 and 192 and two small returns 193 and 194, pivoting in two holes provided in covers 103 and 104.

The simplest case has been depicted here, in which the protective strip 201B extends freely past bar 190, the user tearing off said free end to remove it from time to time when it becomes too long and therefore bothersome.

In a more elaborated version (not shown), the device comprises a second roll onto which the end of strip 201B is wound and which is subsequently removed.

Bar 190 must not offer too much resistance to the advancement toward it of strip 201 and the removal of tape 201A and strip 201B.

That is why the invention provides that bar 190, instead of being smooth as shown in FIGS. 29 and 30, comprises alternating projections and recesses to decrease the coefficient of friction.

In this way, there is less adhesion between bar 190 and tape 201A, primarily because the side of said tape 201A that is in contact with bar 190 is the side coated with adhesive.

FIG. 31 shows a variant of this arrangement in which the alternation of projections and recesses is produced by splines 195 and grooves 196 parallel to its [sic] longitudinal axis.

In FIG. 32, this alternation takes the form of rings 197 and circular grooves perpendicular to its axis.

After engaging tape 201A on one side of bar 190 and protective strip 201B on the other side, the user employs the device as described hereinabove.

In the case of two-sided tape, the protective strip is removed manually after the tape has been applied to the destination surface.

Naturally, other variants can be adopted, particularly oblique or point knurling.

Turning now to FIG. 33, an embodiment of the invention is depicted in which the roll 200 and the applying roller 106 are always in tangential contact with each other to provide constant and even tension in the strip 201, which is an essential characteristic of the invention, but in contrast to the embodiment described above, here the roll 200 is arranged at the front of the device and the applying roller 106 therebehind, with the result that the latter is pressed against the roll 200 by means of the position-maintaining mechanism formed by assembly 108-109-110-11-112 associated with thrust spring 113, said assembly being designed to urge roller 106 constantly toward roll 200, following, as it does so, the periphery thereof, which moves away from it as the strip 201 is unwound, decreasing the diameter of the roll 200.

In the example shown, the roll is mounted on a solid central hub 200a through which passes a central hole in which pivot 105 is engaged. Applying roller 106 is engaged on leg 111 by the transverse central bore that it comprises and which in the preceding embodiment received the pivot 105. In other words, roll 200 and applying roller 105 have been interchanged without altering the characteristic of keeping said roll and said roller 106 in constant contact.

When roll 200 is in the rearward position, i.e., as is the case in the embodiment of FIGS. 1 to 29, it rests both on supporting cylinder 107 and on applying roller 106.

When it is in the rearward position², i.e., as in FIG. 33, supporting cylinder 107 is unused. ²TRANSLATOR'S NOTE: Sic. “Frontward position” is obviously meant.

1. A system comprising, on the one hand, a dispensing device, and on the other hand, at least one roll of strip of great length having a central opening optionally associated with a hub or a core, said system being provided with means for guiding an unwound free end of said strip out of the dispenser and applying it to a surface known as the “destination surface,” said device comprising:
a front portion comprising a location for at least one removable roll able to rotate relative to said front portion on a virtual axis transverse thereto;
an applying roller mounted to be rotatable transversely;
a maneuvering handle,
characterized in that said removable roll (200) and said applying roller (106) are associated with a position-maintaining mechanism (108-113) designed to urge either the roll (200) toward said applying roller (106) or said applying roller (106) toward said roll (200), so that these two elements (200 and 106) are maintained constantly in tangential contact with each other.

2. The system as recited in claim 1, characterized in that said front portion comprises at least one pivotably mounted transverse cylinder (107), serving as a support for said roll (200) so that it rests both on the supporting cylinder (107) and on said applying roller (106) when disposed therebehind.

3. The system as recited in claim 1, whose location for the roll is associated with a position-maintaining mechanism for said roll permitting the use of rolls of more than one outer diameter, characterized in that said applying roller (106) is mounted rotatably on said device in a position that is sufficiently in advance of the location of said roll (200) so that the forwardmost generatrix of said roller (106) is disposed beyond the forwardmost generatrix of the one of the rolls (200) having the largest allowable outer diameter.

4. The system as recited in claim 1, characterized in that said position-maintaining mechanism (108) is constituted by a rod bent into a U shape to comprise a lateral web (109) and two transverse legs (110 and 111), the first (110) of said two legs being pivotably mounted with respect to said support and the second (111) intended to be disposed in the central portion either (202) of said roll (200) or (106a) of said applying roller (106), a spring (113) being engaged with said bent rod to urge it constantly toward its position in which said second leg (111) bears against said central portion either of said roll (200) or of said applying roller (106).

5. The system as recited in claim 4, characterized in that said second leg (111) is surrounded by a freely pivoting tube (181), which further is mounted so as to be able to slide longitudinally between two extreme positions, in one of which its end extends well past the lateral contour of said device, and in the other of which it covers practically all of said second leg (111).

6. The system as recited in claim 4, characterized in that said spring is a coil spring (113) shorter than said first leg (110), on which it is freely engaged, and associated with a mechanism for adjusting its position along said first leg (110).

7. The system as recited in claim 6, characterized in that said first leg (110) is provided with a thread (185), and a nut (186) engaged with said thread (185) is connected to said spring (113) so that they are both movable in translation along said first leg (110), only said nut (186), when engaged, being further rotatably mounted thereon.

8. The system as recited in claim 1, characterized in that said device comprises at least one axial base (120-130) comprising a strut (121-131) and an active portion (122-128-134), said strut (121-131) having a length such that said active portion (122-128-134) is disposed substantially in the same plane (P) as that which contains the generatrix of said applying roller (106) that is to be most proximate said destination surface (S).

9. The system as recited in claim 8, characterized in that said base (120) is disposed rearward of said maneuvering handle (102).

10. The system as recited in claim 8, characterized in that said base (130) is disposed in vertical alignment with the middle portion of said maneuvering handle (102).

11. The system as recited in claim 9, characterized in that said strut (121) of said base (120) is rigid and bears a clevis (124) in which a roller (128) is pivotably mounted, said roller (128) constituting said active portion of said base (120).

12. The system as recited in claim 11, characterized in that said roller (128) is formed of two distinct truncated-cone-shaped parts (145) that are associated with each other either in contact by the opposition of their bases or their apices, or at a distance by a preferably adjustable spacing.

13. The system as recited in claim 10, characterized in that said strut of said base (130) is a flexible leaf (131) that is attached by one of its ends (132) near the front of said maneuvering handle (102) and that is inclined slightly with respect to the axis of said handle (102), the free end (133) of said flexible leaf (131) bearing a shoe (134) that constitutes said active portion of said base (130).

14. The system as recited in claim 1, characterized in that said device is integral with a former (121, 150) disposed behind said applying roller (106), in which said free end of said strip (201) is to be engaged and through which it must pass when the system is in use, so that in back of said former (121-150) it has a different cross section from that which it had in front of said former (121-150).

15. The system as recited in claim 13, characterized in that said former (121) is constituted by a plate that is disposed transversely to the longitudinal axis of the device and that comprises at least one opening (135, 136, 137, 138-139, 157, 171-172) in which said free end of said strip (201) must be at least partly engaged.

16. The system as recited in claim 13, characterized in that said opening (137, 138-139, 157) or each of said openings (135-136, 171-172) is a slit (135, 138-139, 171-172) in which a lateral margin (201g, 201f-201g, 201h-201i) of said free end of said strip (201) is to be engaged.

17. The system as recited in claim 13, characterized in that said opening is constituted by a recess (136) in which a lateral margin (201b) of said free end of said strip (201) is to be engaged.

18. The system as recited in claim 13, characterized in that said former comprises a longitudinal guide (150) whose ends are open, the one (153), constituting the entrance, being near the back of said applying roller (106), while the other (154), constituting the exit, is near the back of said device, said free end of said strip (201) being intended to be engaged in said guide (150).

19. The system as recited in claim 17, characterized in that said guide (150) is formed by a jig.

20. The system as recited in claim 17, characterized in that said guide (150) is formed by a trough.

21. The system as recited in claim 17, characterized in that said guide (150) has a cross section whose shapes at said entrance (153) and at said exit (154) are different.

22. The system as recited in claim 18, characterized in that said cross section of said guide (150) varies continuously from said entrance (153) to said exit (154).

23. The system as recited in claim 17, characterized in that said guide (150) is inclined slightly so that when the system is in use, its outer side near said entrance (153) is at a distance (d) from said destination surface (S) that is greater than that of that same outer side near said exit (154).

24. The system as recited in claim 19, characterized in that it comprises a pressing device (160) engaged in said trough (150) so as to be urged toward the inner face thereof, said strip (201) to be applied being intended to be inserted between said inner face and said pressing device (160).

25. The system as recited in claim 1, whose roll is formed by winding up a strip having two layers that must be separated when the device is used, specifically a layer that is to be applied to the destination surface and a layer that is to be pulled away and removed, characterized in that said device comprises a transverse bar (190) disposed in the vicinity of said applying roller (106), on the near side of the forwardmost generatrix of said roller (106), so that said layer (201A) of said strip (201) that is to be applied to said destination surface (S) extends on one side of said bar (190) and then against said applying roller (106), while the other layer (201B) extends on the other side of said bar (190) so it can be removed.

26. The system as recited in claim 25, characterized in that the surface of said bar (190) comprises alternating projections (195, 197) and recesses (196, 198) so as to possess a low coefficient of adhesion with respect to said strip (201).
